(19) United States
(12) Patent Application Publication
(10) Pub. No.: US 2026/0034762 A1
(43) Pub. Date: Feb. 5, 2026

(54) FLEXIBLE PHENOLIC INTERMINGLED CARBON ABLATORS

(71) Applicant: United States of America as Represented by the Administrator of NASA, Washington, DC (US)

(72) Inventors: Margaret M Stackpoole, Santa Clara, CA (US); Matthew J Gasch, Sacramento, CA (US); Keith Hoppe Peterson, Sunnyvale, CA (US)

(21) Appl. No.: 19/291,581

(22) Filed: Aug. 5, 2025

Related U.S. Application Data
(60) Provisional application No. 63/679,579, filed on Aug. 5, 2024.

(51) Int. Cl. B32B 5/02; B32B 5/26

(52) U.S. Cl. CPC B32B 5/022; B32B 5/26; B32B 2250/02; B32B 2250/20; B32B 2262/106; B32B 2262/144; B32B 2307/306; B32B 2307/72; B32B 2307/7375; B32B 2605/18

(57) ABSTRACT

Flexible phenolic intermingled carbon ablators (PICAs) and processes for making the same are disclosed. These materials, which are also called PICA-Flex herein, combine both carbon and phenolic fiber constituents during the felting process rather than introducing the phenolic through costly and time intensive infusion processes that also use harsh chemicals. PICA-Flex drastically reduces integration complexities when compared to traditional phenolic infused rigid tiles and can eliminate the lengthy phenolic infusion process, resulting in a thermal protection system (TPS) material more akin to a blanket than a rigid TPS. This “blanket” TPS drastically reduces integration complexity when compared to traditional phenolic infused rigid tiles. PICA-Flex encompasses a range of configurations, including a dual layer PICA-Flex material with a higher density outer layer(s) to minimize recession, a lower density PICA-Flex material with applicability to aftbody TPS, and a single piece PICA-Flex forebody.

### CROSS REFERENCE TO RELATED APPLICATION

This application claims the benefit of U.S. Provisional Patent Application No. 63/679,579 filed Aug. 5, 2024. The subject matter of this earlier filed application is hereby incorporated by reference in its entirety.

### ORIGIN OF THE INVENTION

The invention described herein was made by employees of the United States Government and may be manufactured and used by or for the Government of the United States of America for governmental purposes without the payment of any royalties thereon or therefore.

### FIELD

The present invention generally pertains to thermal protection systems (TPSs), and more particularly, to flexible phenolic intermingled carbon ablators and processes for making the same.

### BACKGROUND

Emerging commercial space requires low-cost, rapidly producible, rapidly integratable, environmentally low-footprint processes while maintaining adequate performance and mass efficiency of ablative TPSs. For the past three decades, phenolic impregnated carbon ablators (PICAs) have been the state of the art in ablative entry materials for heat shields for Mars and Earth sample return missions for entry conditions ranging from 100 watts per square centimeter (W/cm²) up to 500 W/cm². PICAs have very low density and highly efficient ablative capability to provide mass efficiency for these heating regimes. A phenolic is a compound characterized by the presence of a hydroxyl group (—OH) bonded to an aromatic ring, which is typically a benzene ring. During the extreme heat of reentry, the phenolic starts to decompose and pyrolize, absorbing heat and releasing pyrolysis gases to help insulate the aeroshell structure.

More recently, the conformal (C-PICA) and soft (S-PICA) variants provide additional benefits beyond traditional rigid PICA, offering reduced density variants with increased strain to failure. All three materials require lengthy infusion processes involving complex equipment and infrastructure, yield toxic byproducts, and the rigid TPS produced requires complex and costly integration processes. Indeed, it can take six months or more of labor to manufacture the rigid or flexible preforms used for the PICAs, followed by a lengthy phenolic resin infusion process and precision machining to implement the final product. This presents a significant hurdle, especially for small startups that lack the ability to invest in long lead time materials. Furthermore, existing rigid PICA materials need to be placed on the vehicle in a tiled configuration requiring high machining and integration tolerances and development of a suitable gap filler material placed between the tiles. The gap filler must have adequate performance when exposed to entry environments. Additionally, such materials are not optimized for the environment in which most commercial reentry activity is expected to occur-low to moderate heat flux environments (e.g., return from low Earth orbit (LEO)). Accordingly, an improved and/or alternative ablative material technology and process for making the same may be beneficial.

### SUMMARY

Certain embodiments of the present invention may provide solutions to the problems and needs in the art that have not yet been fully identified, appreciated, or solved by conventional ablative materials, and/or a useful alternative thereto. For example, some embodiments of the present invention pertain to flexible phenolic intermingled carbon ablators and processes for making the same.

In an embodiment, a flexible phenolic intermingled carbon ablator (PICA-Flex) material includes carbon fibers and phenolic fibers combined during a felting process.

In another embodiment, a PICA-Flex material includes carbon fibers and phenolic fibers combined during a felting process. The PICA-Flex material is a dual layer material including an inner layer and an outer layer with a higher density than the inner layer. The outer layer is all carbon and the inner layer comprises blended carbon and phenolic fibers.

In yet another embodiment, a PICA-Flex material includes carbon fibers and phenolic fibers combined during a felting process. The PICA-Flex material can provide thermal protection for and withstand heat flux conditions of up to 1,500 watts per square centimeter (W/cm²). The phenolic fibers have lengths of 0.5 to 4 inches.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a scanning electron microscope (SEM) image of a microstructure of the PICA-Flex manufacturing demonstration material, highlighting the intermingled nature of the felt, according to an embodiment of the present invention.

FIG. 2 illustrates felting equipment for producing PICA-Flex material, according to an embodiment of the present invention.

FIG. 3 illustrates PICA-Flex felted material architecture, where carbon and phenolic intermingled fiber battings are laid down at different orientations and needle punched (or felted) to yield a transversely isotropic felt of higher density than the battings, according to an embodiment of the present invention.

FIG. 4 illustrates near-net forming of a full-scale aeroshell PICA-Flex material on a capsule, according to an embodiment of the present invention.

FIG. 5 illustrates an industrial robot that is equipped with a needle punching head.

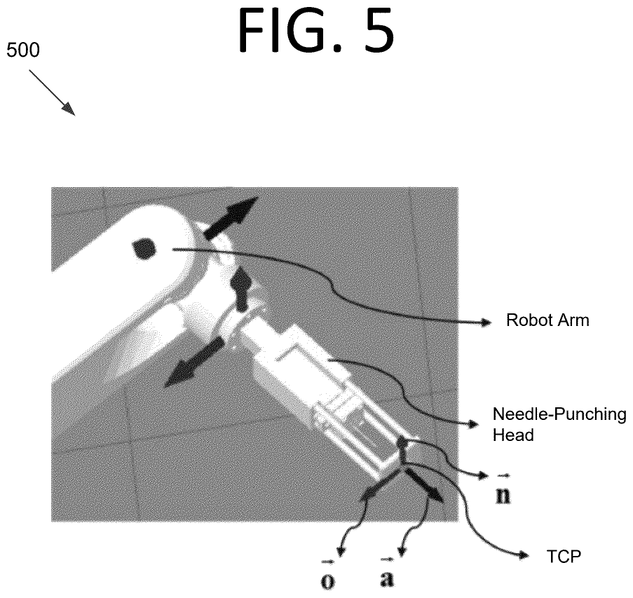

FIG. 6 is a graph illustrating thermal conductivity at a range of temperatures for various PICA materials, according to an embodiment of the present invention.

FIG. 7 is a flowchart illustrating a method of making PICA-Flex, according to an embodiment of the present invention.

Unless otherwise indicated, similar reference characters denote corresponding features consistently throughout the attached drawings.

### DETAILED DESCRIPTION OF THE EMBODIMENTS

Some embodiments of the present invention pertain to flexible phenolic intermingled carbon ablators and processes for making the same. The ablators may include, but are not limited to, high char yield materials such as oxidized PAN (polyacrylonitrile), para-aramid, meta aramid, a combination thereof, etc. These materials, which are also called “PICA-Flex” herein, combine both carbon and phenolic fiber constituents during the felting process rather than introducing the phenolic through costly and time intensive infusion processes that also use harsh chemicals. Combining a carbon and a phenolic material includes physically bringing the materials together by a felting process using needling to create a new material of carbon fibers intermingled with phenolic fibers. The family of PICA-Flex materials is also called Materials Engineered for Re-entry using Innovative Needling Operations (MERINO).

PICA-Flex drastically reduces integration complexities when compared to traditional phenolic infused rigid tiles, which require precision machining and integration steps. Doing so eliminates the lengthy phenolic infusion process, resulting in a TPS material more akin to a blanket than a rigid TPS. This “blanket” TPS drastically reduces integration complexity when compared to traditional phenolic infused rigid tiles, resulting in significant cost and schedule savings when compared to traditional rigid TPS materials. Indeed, it is possible to create and install the PICA-Flex material within a week or two in-house for relatively small scale vehicles. As such, PICA-Flex may help the emerging commercial space market by meeting low to moderate heat flux requirements that are orders of magnitude less expensive but just as capable as, if not better than, previous TPS materials. Furthermore, relatively large areas of PICA-Flex can be produced and installed on the spacecraft without a lot of direct or touch labor hours, thus reducing installation time and increasing safety. Additionally, due to its flexibility, PICA-Flex may allow differently shaped and potentially larger spacecraft to be produced with limited gaps and seams. Heat shields for Mars are typically 5 meters in diameter.

The material typically requires no further post-processing prior to trimming and bonding. PICA-Flex encompasses a range of configurations and compositions including, but not limited to, a dual layer PICA-Flex material with a higher density outer layer(s) to minimize recession, a lower density PICA-Flex material (e.g., on the order of 0.12 grams per cubic centimeter (g/cc) to 0.28 g/cc) with applicability to aftbody TPS, and a single piece PICA-Flex forebody. In the case of the dual layer PICA-Flex material, an all carbon surface and blended carbon and phenolic fibers underneath may be used. Such embodiments may be used to bring back samples from Mars, for example.

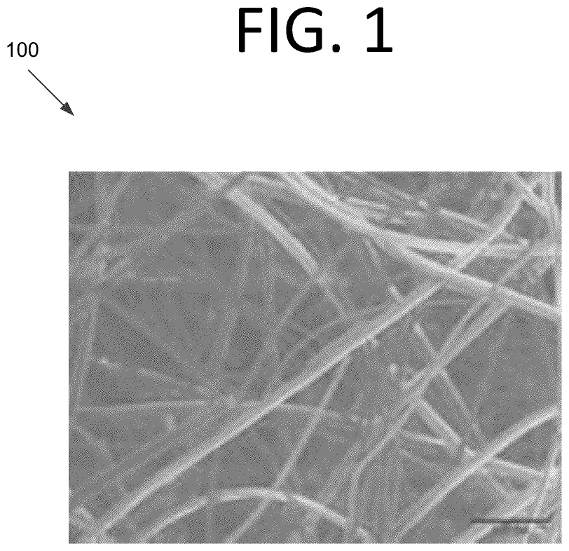

PICA-Flex is fabricated by combining by intermingling both carbon and phenolic fiber constituents during a needle punch felting process during which the fibers are made into battings, and the battings are needled together layer-by-layer to build up thickness. See SEM image 100 of FIG. 1, which highlights the intermingled PICA-Flex felt. In this process of combining carbon and phenolic fiber constituent materials, a needle is inserted and removed, which snag, catches, and pushes fibers and draws them through the layers and deposits them in the hole created by the path of the needle, intermingling the caught fibers with the layers. This needling process results in interconnectivity between layers of batting and allows for custom optimization of the felted material. Optimizations may include graded material in density, constituents, and the amount of needling for improved interlaminar tensile properties. The result is a non-rigid (blanket-like) TPS material suitable for relatively low heat environments (e.g., up to ˜1,500 W/cm² heat flux conditions, depending on pressure).

Introducing the phenolic material in the felting process in the form of a fiber can eliminate the need for a lengthy phenolic infusion process. This drastically reduces integration complexities when compared to traditional phenolic-infused rigid tiles. The material requires no further post-processing prior to bonding to the aeroshell structure, like other blanket type TPS materials. PICA-Flex can offer a significant cost and schedule savings compared to traditional phenolic infused material such as PICA, C-PICA, and S-PICA. Furthermore, PICA-Flex is expected to offer a significant mass savings given the lower thermal conductivity and density of PICA-Flex compared to PICA and C-PICA, for example. Given the benefit of requiring less infrastructure (e.g., infusion ovens and such) PICA Flex can be more readily established on site at multiple commercial space partners.

The PICA-Flex felted ablative material fills a technology gap in TPS. It can provide relatively low cost, low mass, easily integrated, and quick turnaround heatshield systems primarily for low heat flux environments (e.g., LEO, Mars entry, etc.). PICA-Flex may also be used as a back shell TPS solution for more demanding missions replacing the heritage PICAs. The blanket-like PICA-Flex material can be integrated onto aeroshell structures considerably more easily than existing PICA or other TPS materials. Thus, some embodiments provide a more straightforward process for producing low-density carbon phenolic.

Per the above, PICA-Flex eliminates the phenolic infusion process, which is lengthy, costly, requires specialized equipment, and generates toxic byproducts. Additionally, removing the infusion process removes rigidity in the virgin material. This provides the material with its compliant “flex” property, which significantly reduces integration complexity and cost relative to traditional phenolic-infused tiles.

Ease of integration of PICA-Flex also reduces costs. Indeed, in some embodiments, PICA-Flex can have costs more than 75% less than those of rigid PICA. The eliminated phenolic infusion step reduces fabrication costs. Raw material costs for PICA-Flex may be higher in some embodiments, but the aforementioned savings are expected to be greater than this increase. Refurbishment/replacement of PICA-Flex is also favorable and offers substantial labor and time savings compared to rigid PICAs.

Given that PICA-Flex is optimized for low-to-moderate heat flux environments it is low density and lower mass as compared to rigid PICA and other TPS materials. PICA-Flex also reduces TPS turnaround time. Given that PICA-Flex does not require complex and lengthy integration processes, it can be manufactured and integrated much more rapidly than traditional TPS materials. PICA-Flex can also be readily customized. The needling process allows for customization of the TPS material (e.g., density, constituents, amount of needling for interlaminar tensile properties, etc.). Per the above, PICA-Flex is also tailored for reentry environments relevant to commercial space. PICA-Flex maintains adequate performance and mass efficiency for low-to-moderate heat flux environments, such as LEO return operations.

PICA-Flex in some embodiments can be used in low-to-moderate heat flux entry environments (e.g., LEO, entry to Mars, etc.) and low-pressure, high heat flux environments (e.g., ˜500 W/cm²), such as aerocapture missions to ice giants. These lower heat flux capabilities represent a tradeoff made to achieve low mass, eliminate the phenolic infusion process, reduce manufacturing cost and schedule time, and enable straightforward integration. From a commercial perspective, PICA-Flex is mostly suitable as a TPS for heatshield and back shell applications in LEO (the location of most commercial activity). PICA-Flex may also have applications for thermal protection of reusable launch vehicles.

Existing felting technologies are typically optimized for textiles (e.g., wool, cotton, rayon, etc.). Felting has not previously been used for blending carbon and phenolic fibers, nor have felted carbon and organic fiber products been produced for TPS applications. Carbon fibers derived from PAN may be used for PICA-flex as they are offered by many carbon fiber suppliers and may eliminate supply chain issues. In some embodiments, fiber lengths and carbon-to-phenolic ratios are critically important. It is also important that the TPS material should be shape stable so the vehicle maintains its outer mold line, and does not have large in-plane shrinkage on heating. Phenolic fiber lengths of 0.5 to 4 inches may be used in some embodiments. If the fibers are too long, the felted products do not have the requisite characteristics, and felting starts becoming unwieldy. On the other hand, if the fibers are too short, they tend to pull apart, and do not have the requisite structural integrity.

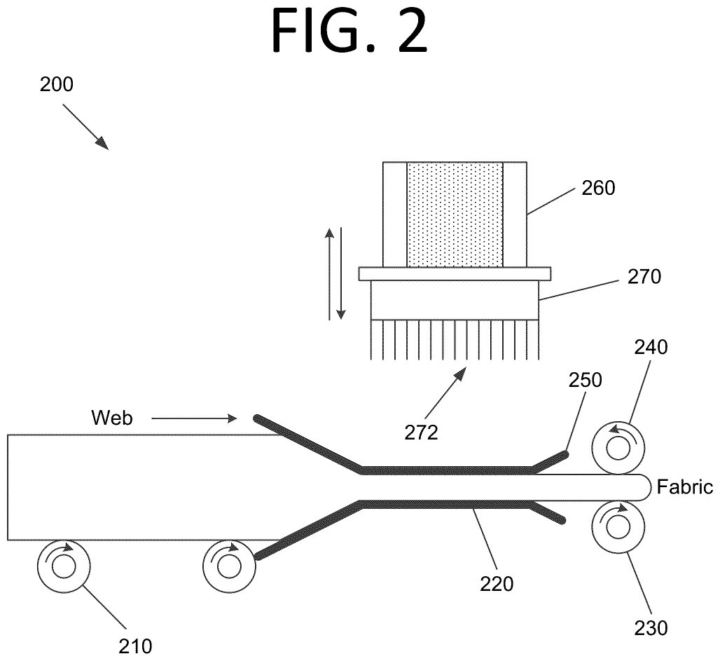

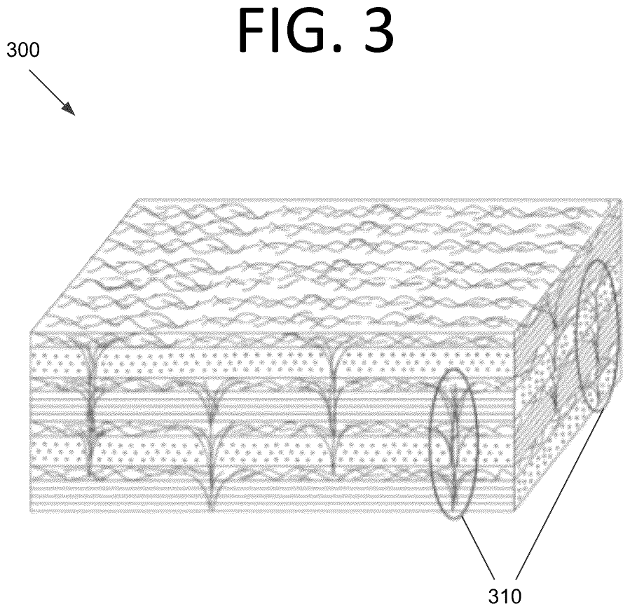

FIG. 2 illustrates felting equipment 200 for producing PICA-Flex material, according to an embodiment of the present invention. Felting equipment 200 includes a feed apron 210, a bed plate 220, a draw roll 230, a pressing roll 240, a stripper plate 250, a needle beam 260, and a needle board 270 with needles 272. Needles 272 may have a curvature to facilitate felting of PICA-Flex. Per the above, PICA-Flex is fabricated by intermingling both carbon and phenolic fiber constituents during a needle punch felting process by use of felting equipment, such as felting equipment 200, during which the fibers are needled layer-by-layer to build up thickness. This needling process results in interconnectivity between layers and allows for custom optimization of the felted material. An example of PICA-Flex felted material 300 with needled fibers 310 produced by such a process is shown in FIG. 3. The density of the resulting PICA-FLEX felt can be controlled by the needle punching parameters (e.g., needle punch density, etc.).

PICA-Flex is produced by needle punching individual layers of blended carbon-phenolic batting. Unlike traditional rigid ablative tiles that require costly and time intensive infusion processes, PICA-Flex intermingles carbon and phenolic fiber to create the batting layers. These layers of batting are then needle punched together to produce a nonwoven felt material that is more akin to a blanket than a rigid TPS. This ablative blanket significantly reduces manufacturing and integration complexity while simultaneously satisfying performance requirements.

This process is conducive to creating a dual layer, or functionally graded material. Equipment has been modified to yield felts of thicknesses needed for TPS. The technical approach for satisfying this is accomplished by increasing the density of the bottom layers, and in some embodiments, adjusting the carbon-to-phenolic-fiber ratio in the felt. This higher density felted material may then be characterized for char yield, density, thermal conductivity, thermo-gravimetric analysis (TGA), and through thickness (TT) tension tests, to insure adequate thermal protection protection.

The needle punching process also presents a unique opportunity to fabricate a near-net forebody or backshell single piece heatshield shape on a capsule. Batting layers can be laid up in a female tool to create the compound curvature required for a sphere cone. This layup approach is similar to the standard process with traditional composites that are manufactured with an optimal layup pattern. For example, a 45° degree sphere cone aluminum aeroshell that is approximately 32 inches in diameter may be covered with PICA-Flex material. Used as a female tool, layers of batting can be needled together. This process can be repeated until the desired thickness is achieved. The resulting near-net portion may then be sectioned and characterized for char yield, density, thermal conductivity, TGA, and TT tension tests-all characterizations that are useful to evaluate the system. Test data from the curved part may be compared against flat felted PICA-Flex products to insure adequate thermal protection properties. In some embodiments, this layup technique may be automated.

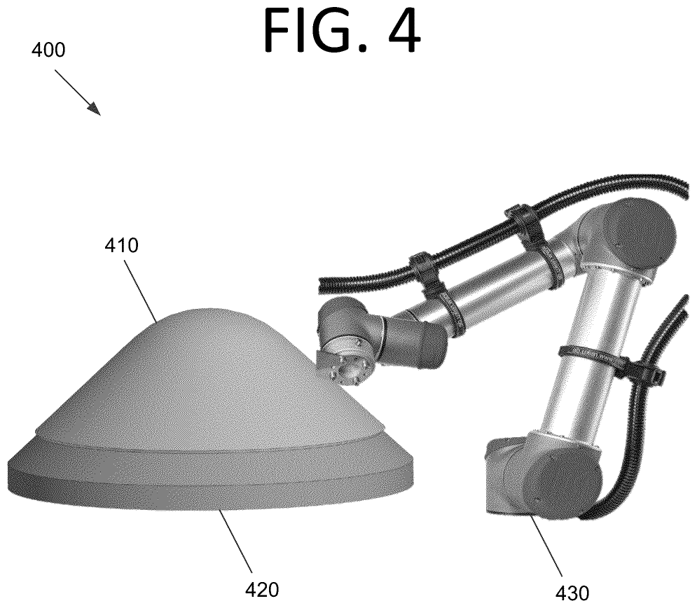

Some embodiments may have a lower density of PICA-Flex to ˜0.12 g/cc, reduced from the nominal 0.2 g/cc demonstrated on materials fabricated to optimize properties for more benign backshell TPS applications. Fully dense carbon phenolic has a density of ˜1.5 g/cc and mid-density carbon phenolics have a density of ˜0.78 g/cc. As with other materials, this lower density felt material would have tests performed to characterize its properties and behavior in representative entry conditions. FIG. 4 shows an example 400 of near-net forming of a full-scale aeroshell PICA-Flex material 410 on a capsule 420, according to an embodiment of the present invention. Automated needling of PICA-Flex material 410 is performed by an industrial robot 430.

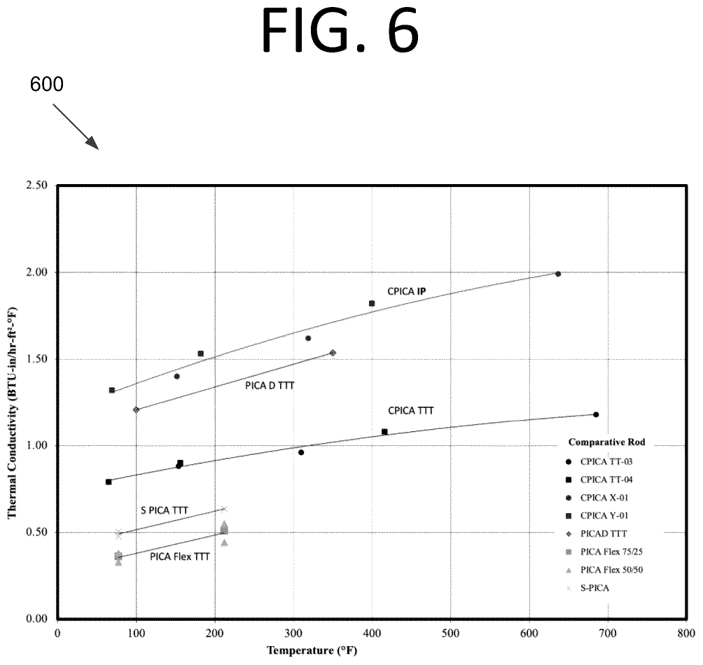

An ablative TPS blanket, like PICA-Flex, is scalable to any diameter, does not need precision machining, and does not need room temperature vulcanized (RTV) silicon-filled seams between tiles, which radically simplifies the design, analysis, and integration processes of TPS on future NASA Mars Exploration Program MEP missions, for example. A needle head may be designed for a given TPS application. For instance, in some embodiments, IRB 6700 industrial robots may be used. A graph 600 of thermal conductivity versus temperature for various PICA materials is shown in FIG. 6. The lower thermal conductivity of PICA-FLEX is favorable compared to the other PICAs.

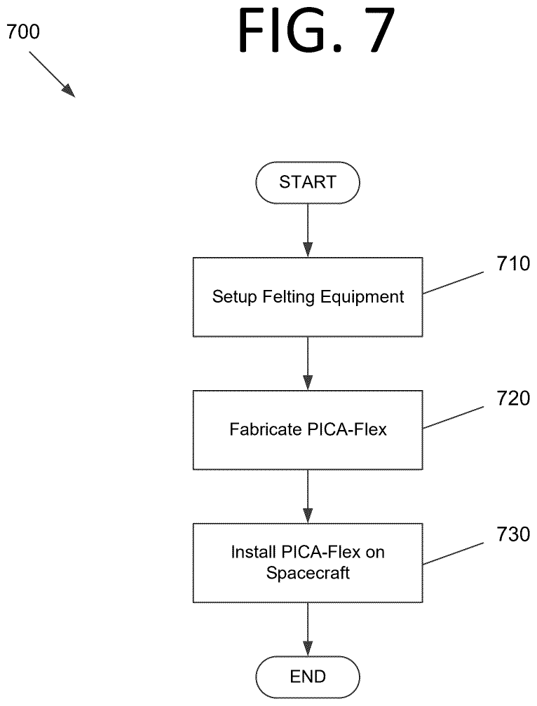

FIG. 7 is a flowchart illustrating a process 700 for producing PICA-Flex material, according to an embodiment of the present invention. The process begins with setting up felting equipment at 710. PICA-Flex is fabricated at 720 by intermingling both carbon and phenolic fiber constituents during a needle punch felting process via felting equipment, during which the fibers are needled layer-by-layer to build up thickness. This needling process results in interconnectivity between layers and allows for custom optimization of the felted material. PICA-Flex is then installed on a spacecraft at 730.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A flexible phenolic intermingled carbon ablator (PICA-Flex) material, comprising:
carbon fibers and phenolic fibers combined using a felting process.

2. The PICA-Flex material of claim 1, wherein the PICA-Flex material is a dual layer material comprising an inner layer and an outer layer with a higher density than the inner layer.

3. The PICA-Flex material of claim 1, wherein the outer layer is all carbon and the inner layer comprises blended carbon and phenolic fibers.

4. The PICA-Flex material of claim 1, wherein the PICA-Flex material has a density for aftbody thermal protection system (TPS) applications.

5. The PICA-Flex material of claim 1, wherein the PICA-Flex material is a single piece forebody for a spacecraft.

6. The PICA-Flex material of claim 1, wherein the PICA-Flex material comprises needled fibers.

7. The PICA-Flex material of claim 1, wherein the PICA-Flex material provides thermal protection in heat flux conditions of up to 500 watts per square centimeter (W/cm²).

8. The PICA-Flex material of claim 1, wherein the phenolic fibers have lengths of 0.5 to 4 inches.

9. The PICA-Flex material of claim 1, wherein the PICA-Flex material has a density of 0.12 to 0.28 grams per cubic centimeter (g/cc).

10. A flexible phenolic intermingled carbon ablator (PICA-Flex) material, comprising:
carbon fibers and phenolic fibers combined using a felting process, wherein
the PICA-Flex material is a dual layer material comprising an inner layer and an outer layer with a higher density than the inner layer, and
the outer layer is all carbon and the inner layer comprises blended carbon and phenolic fibers.

11. The PICA-Flex material of claim 10, wherein the PICA-Flex material has a density for aftbody thermal protection system (TPS) applications.

12. The PICA-Flex material of claim 10, wherein the PICA-Flex material is a single piece forebody for a spacecraft.

13. The PICA-Flex material of claim 10, wherein the PICA-Flex material comprises needled fibers.

14. The PICA-Flex material of claim 10, wherein the PICA-Flex material provides thermal protection in heat flux conditions of up to 500 watts per square centimeter (W/cm²).

15. The PICA-Flex material of claim 10, wherein the phenolic fibers have lengths of 0.5 to 4 inches.

16. The PICA-Flex material of claim 10, wherein the PICA-Flex material has a density of 0.12 to 0.28 grams per cubic centimeter (g/cc).

17. A flexible phenolic intermingled carbon ablator (PICA-Flex) material, comprising:
carbon fibers and phenolic fibers combined during a felting process, wherein
the PICA-Flex material provides thermal protection in heat flux conditions of up to 1,500 watts per square centimeter (W/cm²), and
the phenolic fibers have lengths of 0.5 to 4 inches.

18. The PICA-Flex material of claim 17, wherein
the PICA-Flex material is a dual layer material comprising an inner layer and an outer layer with a higher density than the inner layer, and
the outer layer is all carbon and the inner layer comprises blended carbon and phenolic fibers.

19. The PICA-Flex material of claim 17, wherein the PICA-Flex material comprises needled fibers.

20. The PICA-Flex material of claim 17, wherein the PICA-Flex material has a density of 0.12 to 0.28 grams per cubic centimeter (g/cc).
